(19) United States
(12) Patent Application Publication
(10) Pub. No.: US 2007/0206533 A1
(43) Pub. Date: Sep. 6, 2007

(54) METHOD AND SYSTEM OF INTERRUPTING A TRANSMITTING SUBSCRIBER IN A WIRELESS COMMUNICATIONS SYSTEM

(75) Inventors: DAVID G. WIATROWSKI, WOODSTOCK, IL (US); JOHN P. BELMONTE, SCHAUMBURG, IL (US); DIPENDRA M. CHOWDHARY, HOFFMAN ESTATES, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/680,813

(22) Filed: Mar. 1, 2007

Related U.S. Application Data
(60) Provisional application No. 60/778,737, filed on Mar. 3, 2006.

(51) Int. Cl. H04Q 7/00

(52) U.S. Cl. 370/329; 455/450; 455/509

(57) ABSTRACT

Disclosed is a method and system for interrupting a transmitting subscriber where the transmitting subscriber communicates on a forward channel of a wireless communications system while listening to a reverse channel for reverse channel signaling. The transmitting subscriber receives reverse channel signaling on the reverse channel from a second subscriber, wherein the message is received either directly from the second subscriber or through at least one base radio and terminates the communication on the forward channel in response to the received reverse channel signaling.

### CROSS REFERENCE TO RELATED APPLICATIONS

The present application claims the benefit of U.S. provisional application No. 60/778,737 filed Mar. 3, 2006, which is incorporated by reference as if fully set forth. The present application is also related to co-pending U.S. patent application Ser. No. 10/799,035, entitled “Method of Signaling Reverse Channel Information with Minimal Voice/Data Delay,” filed on 12 Mar. 2004 and assigned to Motorola, Inc. which is hereby incorporated by reference as if fully set forth.

### FIELD OF THE INVENTION

The present invention relates generally to wireless communications systems and more specifically to interrupting a transmitting subscriber in a wireless communications system.

### BACKGROUND

A wireless communications system may generally comprise a set of “subscribers,” typically subscribers are the endpoints of a communication path, and a set of “base radios,” typically stationary and the intermediaries by which a communication path to a subscriber may be established or maintained. One such type of system is a time division multiple access (TDMA) communications system where the radio medium is divided into time slots to carry the communications of the system.

When a subscriber is transmitting communications, there may be instances when interrupting the transmitting subscriber may be important. For example, a first police officer needing back up may need to interrupt a second police officer that is engaged in a call. In such an instance, it would be important to have a mechanism to interrupt the second police officer to notify the second officer that the first police officer requires assistance.

Accordingly, there is a need for interrupting a transmitting subscriber in a wireless communications system.

### BRIEF DESCRIPTION OF THE FIGURES

An illustrative embodiment of the invention is now described, by way of example only, with reference to the accompanying figures in which:

FIG. 1 is a block diagram of an example wireless communications system in accordance with an embodiment of the invention.

FIG. 2 is a block diagram of an example reverse channel burst on the outbound channel in accordance with an embodiment of the invention.

FIG. 3 is a block diagram of an example of a reverse channel burst on the inbound channel in accordance with an embodiment of the invention.

FIG. 4 is a flow diagram of an example operation of a subscriber transmitting in the wireless communications system of FIG. 1 in accordance with an embodiment of the invention.

FIG. 5 is a flow diagram of an example operation of a subscriber initiating an interrupt in the wireless communications system of FIG. 1 in accordance with an embodiment of the invention.

FIG. 6 is a block diagram of an example remote control request message in accordance with an embodiment of the invention.

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

### DETAILED DESCRIPTION

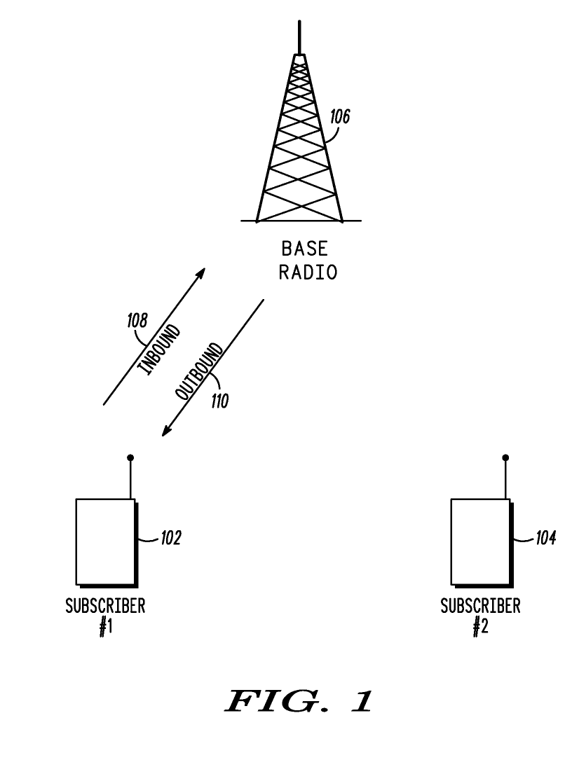

Referring now to FIG. 1, there is shown an example wireless communications system 100 where wireless communications take place between subscribers, namely subscriber 102 and subscriber 104, either directly or via a base radio, namely base radio 106. The subscribers and base radio are communicating with each other via an RF medium assigned to the wireless communications system 100.

In the wireless communications system 100, an air interface protocol is used to manage access to the RF medium. In one example, the RF medium is divided into slots (also known in the art as “channels”) so that the various slots carry different information, e.g. carrying control information common to channels, carrying voice or data payload, and carrying signaling information (e.g., synchronization and embedded signaling). In one example, the wireless communications system 100 is a time division multiple access (TDMA) communications system having time slots. In another example, the wireless communications system 100 adheres to ETSI standard TS 102 361.

The wireless communications system 100 may be configured so that a subscriber may receive signaling information while transmitting. As is known to one of ordinary skill in the art, the channel that carries signaling while the subscriber is transmitting payload (e.g. as a part of a call) is termed the “reverse channel” and the control information sent on the reverse channel is termed “reverse channel signaling.” Likewise, the channel that the subscriber is utilizing for transmitting payload is termed the “forward channel.”

In any case, regardless of whether the channel is a “forward channel” or a “reverse channel,” the communication may be of an inbound direction, which means that the communication is from the subscriber to a base radio, e.g. as shown in FIG. 1 as 108. The communication may be of an outbound direction, which means that the communication is from the base radio to the subscriber, e.g. as shown in FIG. 1 as 110. Even though the inbound and outbound directions are shown with respect to a base radio (termed “indirect mode”), the same definitions can be applied to communications directly between subscribers (termed “direct mode”). That is, signaling from subscriber 102 to subscriber 104 may be termed inbound and signaling from subscriber 104 to subscriber 102 may be termed outbound.

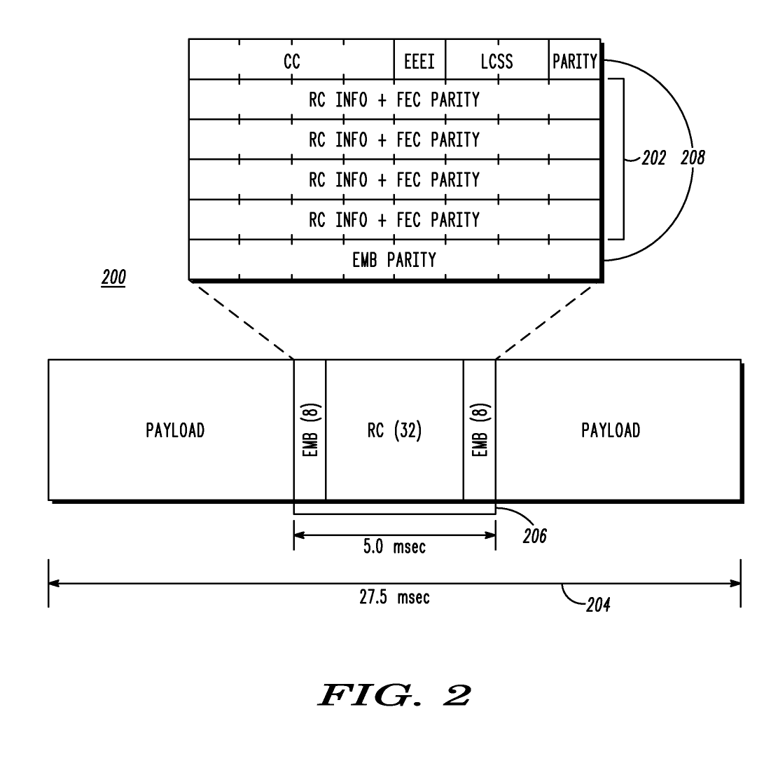

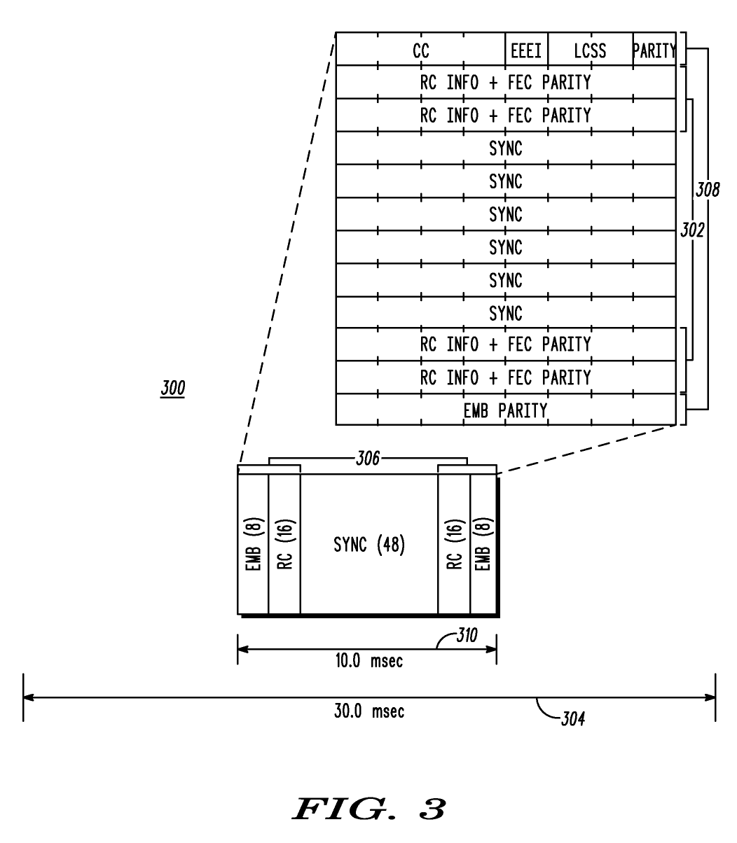

In one embodiment, the wireless communications system 100 is a two-slot TDMA communications system that has two 6.25 kHz equivalent logical channels which share a single 12.5 kHz physical channel. The two slots allow a subscriber to alternately transmit on one channel and receive control information, e.g. the reverse channel signaling, on the other channel. In one example of the two-slot TDMA communications system, an entire slot does not carry control information, but only a center portion of the slot carries the control information. In another example of the two-slot TDMA communications system, an entire slot does not carry information, but only a center portion of the slot carries synchronization and/or control information. For the outbound channel (e.g. as shown in FIG. 2), only the center 5 msec portion of the slot carries control information whereas for the inbound channel (e.g. as shown in FIG. 3), the center 10 msec portion of the slot carries control information. By confining the control information to the center of the time slot, subscribers that are slower to change frequencies may be used. As is known in the art, described in the figures is only one embodiment of the invention. Alternatives such as the center portions of the burst carry either control and/or synchronization are well known and considered to be equivalent. Further known, even though the term “inbound channel” is used, the inbound channel may be used for subscriber to subscriber communications (also termed “direct mode” as described above).

In one embodiment, the format of the reverse channel signaling in an outbound direction, e.g. 110, is a part of the outbound channel burst 200 as shown in FIG. 2. In one embodiment, the outbound channel burst 200 has duration 204 of 27.5 msec and the slot that carries the outbound channel burst 200 is of 30 msec. In any case, the center 206 of the outbound channel burst 200 having duration of 5 msec carries the reverse channel signaling 206 and is between payload. In one embodiment, the reverse channel signaling 206 is 32 bits of reverse channel information 202 and 16 bits of embedded information 208. In one example, the 32 bits of reverse channel information 202 comprises 11 bits of RC info and 21 bits of FEC Parity.

In one embodiment, the format of the reverse channel signaling in the inbound direction, e.g. 108, is called a reverse channel burst 300 as shown in FIG. 3. In one embodiment, the reverse channel burst 300 has duration 310 of 10 msec and the slot that carries the reverse channel burst 300 is of 30 msec in duration 304. In any case, the center of the reverse channel burst 300 carries the synchronization (e.g. a 48-bit synchronization word) and the rest of the reverse channel burst 300 carries the reverse channel signaling 306. Notice, that shown in FIG. 3 is reverse channel signaling 306 having a noncontiguous 32-bit field, but in other embodiments, the reverse channel signaling 306 may be contiguous. In any case, in one example, the reverse channel signaling 306 is 32 bits of reverse channel information 302 and 16 bits of embedded information 308. In one example, the 32 bits of reverse channel information 302 comprises 11 bits of RC info and 21 bits of FEC Parity. In any case, the inbound reverse channel burst shown in FIG. 3 allows a subscriber to send reverse channel signaling on an inbound channel whether directly to another subscriber or via a base radio.

In one embodiment, the 11 bits of RC info in either 32 bit fields 202 or 302 are defined as 3 bits for conveying format or opcode information, 5 bits for conveying message dependent information, and 3 bits for a cyclic redundancy check (CRC) which can be used for error detection.

As is known to one of ordinary skill in the art, the information contained in the bursts, the length of fields, and the order of information as shown in the figures is representative and is not meant to be a limitation on an embodiment of the present invention.

Further used herein, the terms “communication” and “transmission” are used interchangeably and refer to contiguous TDMA bursts emanating from one subscriber in one slot. As such, transmissions may generically refer to voice, data or control information relating to the wireless communications system 100. The term “call” refers to related voice transmissions between subscribers in the wireless communications system 100.

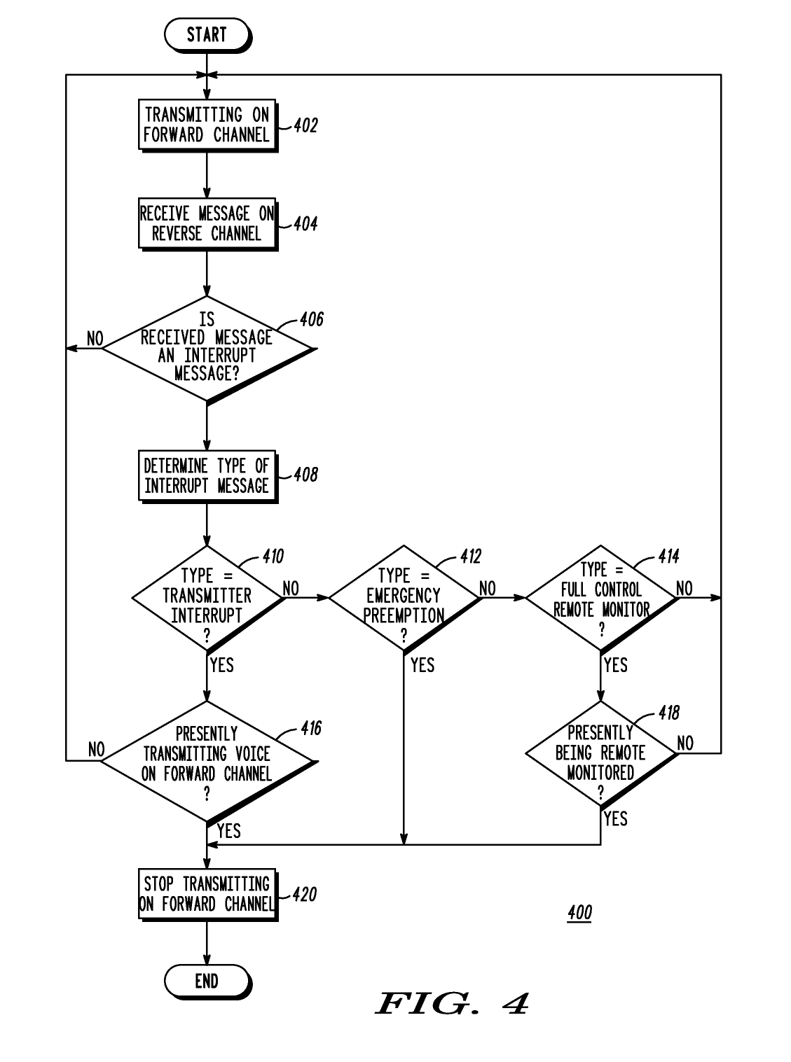

Referring to FIG. 4, shown is a flow diagram 400 of an operation of a subscriber, e.g. a first subscriber 102, transmitting in a forward channel (step 402). As mentioned above, the transmission may be voice, data, or control. In an embodiment, the subscriber is engaged in a call with another subscriber, e.g. a second subscriber 104. While the subscriber is transmitting on the forward channel (e.g. while engaged in a call with the second subscriber), the subscriber receives a message on the reverse channel (step 404). If the subscriber determines that the received message is an interrupt message (step 406), then the subscriber determines the type of interrupt (step 408). If the subscriber determines that the received message is not an interrupt message (step 406), then the subscriber returns to transmitting on the forward channel (step 402).

In one embodiment, determining that the received message is an interrupt message requires checking that the 3 bit opcode field of the RC info in the outbound channel burst (shown as 200 in FIG. 2) is 001, where the opcode 001 means to interrupt the transmitting subscriber.

In one embodiment, the subscriber is provisioned so that the subscriber can be interrupted during transmissions. As is known to one of ordinary skill in the art, “provisioned” means that the subscriber is programmed with an attribute or feature which instructs the subscriber how to operate. In an illustrative embodiment, Customer Provisioning Software (CPS) (also known as Radio Service Software (RSS)), manufactured by Motorola, Inc., is used for assigning the subscriber a provisioned characteristic, e.g. enabling interruptions and/or enabling reverse channel signaling. In such an embodiment, the subscriber determines that it is provisioned for being allowed to be interrupted and performs the steps of FIG. 4.

In any case, if reverse channel signaling is enabled in a subscriber to be interrupted, a user of a subscriber performing the interrupting should not be able to notice that such a feature is enabled. For example, if the user of the subscriber performing the interrupting pushes push-to-talk (PTT), the subscriber clears the channel and enables the user to transmit, without additional steps that the user has to take to normally place a call. Thus, from a user's perspective, the operation of the subscriber remains the same.

Returning to FIG. 4, if the subscriber can be interrupted and the received message is an interrupt message, then in one embodiment, the subscriber determines the type of interrupt (step 408). In such an embodiment, the subscriber may be interrupted for a number of reasons. Some examples of such reasons include because another subscriber needs to use the channel immediately (called “transmitter interrupt”), another subscriber in an emergency mode needs to use the channel immediately (called “emergency preemption”), another subscriber in remote control mode is requesting the channel immediately (called “control of remote monitor”).

In one embodiment, the subscriber determines the type of interrupt (step 408), by decoding the RC info of the outbound channel burst 200 (shown in FIG. 2). In one embodiment, 5-bits of the RC Info are used to indicate the interrupt type. For example, in one embodiment, “transmitter interrupt” is indicated by the 5-bits 00001, “emergency preemption” is indicated by the 5-bits 00010, and “control of remote monitor” is indicated by the 5-bits 00011. As is known to one of ordinary skill in the art, the subscriber can be interrupted for many reasons and new types of interrupts may be created. As such, the message may be identified utilizing the 5-bit information field of the reverse channel signaling burst.

Returning to FIG. 4, if the subscriber determined that the interrupt message is of type “transmitter interrupt” (step 410), then the subscriber stops transmitting (step 420) if the subscriber is presently transmitting voice on the forward channel (step 416). Thus, the “transmitter interrupt” message is used to interrupt (also called pre-empt) a subscriber that is engaged in a call, e.g. a group call, a private call, an “all” call, or an emergency voice call. By doing so, the wireless communications system provides priority call control. If the subscriber is not presently transmitting voice on the forward channel (step 416), the subscriber continues to transmit (e.g., non-voice) on the forward channel (step 402) and the received interrupt message does not affect the operation of the subscriber.

If the subscriber determined that the interrupt message is of type “emergency preemption” (step 412), then the subscriber immediately stops transmitting regardless of whether the subscriber was engaged in a call or non-voice communication (e.g. a data or control communication) (step 420). In one embodiment, the subscriber additionally emits a tone denoting that the subscriber has been preempted. Emergency preemption stops any ongoing transmission and, in one embodiment, starts a new call for the subscriber performing the interrupting.

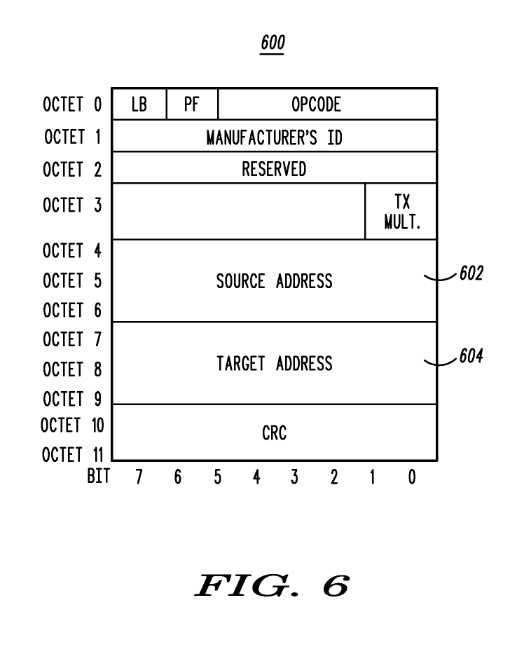

If the subscriber determined that the interrupt message is of type “control of remote monitor” (step 414), then the subscriber stops transmitting (step 420) if the subscriber is presently being monitored (step 418). Thus, the “control of remote monitor” message is used to interrupt a subscriber that has been previously set to a remote control mode, e.g. by receiving a remote control request message 600 (also called a control signaling block CSBK) as shown in FIG. 6 where the remote control request message 600 identifies the subscriber being monitored via source and target addresses 602, 604. If the subscriber is not presently in a remote control mode (step 418), the subscriber continues to transmit on the forward channel (step 402) and the received interrupt message does not affect the operation of the subscriber. In one embodiment, the remote control mode allows another subscriber to remotely activate the subscriber's microphone without providing any indication to the user of the monitored subscriber. It also allows the subscriber to be keyed up and/or de-keyed.

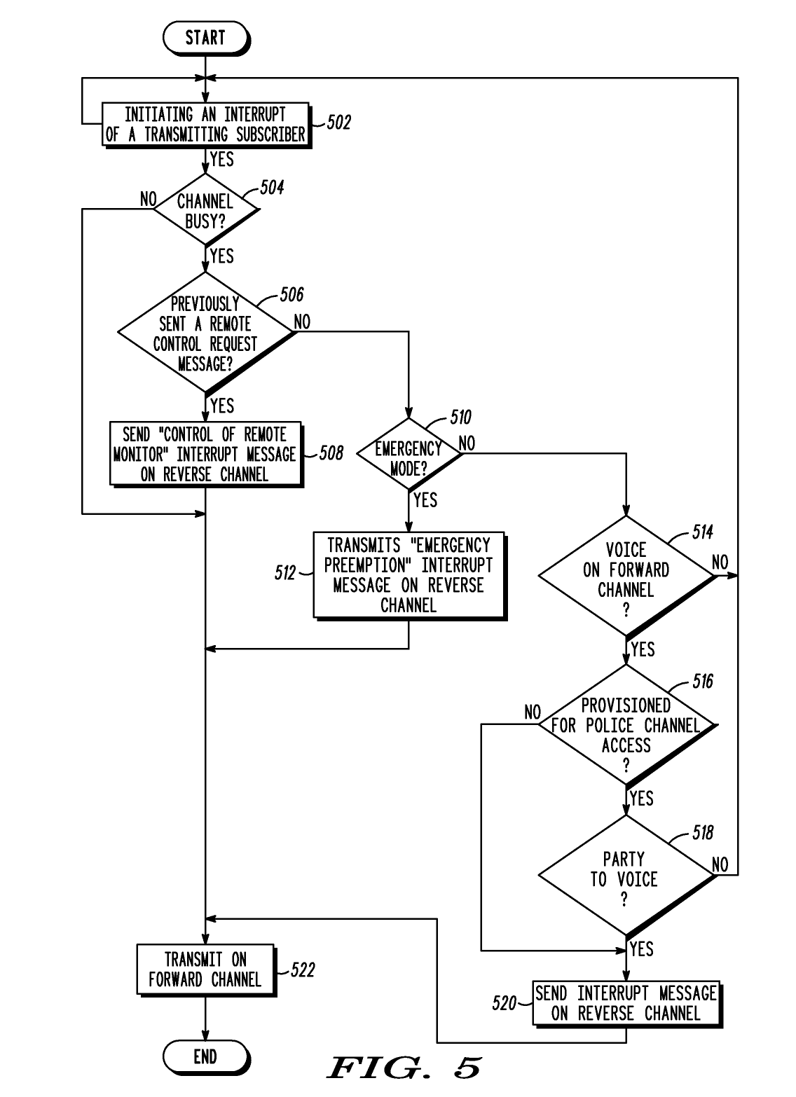

Referring to FIG. 5, shown is a flow diagram 500 of an operation of a subscriber, e.g. a second subscriber 104, initiating an interrupt of a transmitting subscriber (e.g. a first subscriber 102) (step 502). In one embodiment, the subscriber that initiates the interrupt, e.g. by sending an interrupt message, may initiate the interrupt message by a user of the subscriber pressing a PTT button, navigations buttons, a programmable button, or a button on an accessory that is mapped to interrupt a call.

If the subscriber determines that the channel is busy (step 504), then the subscriber continues to determine whether the subscriber may interrupt the transmitting subscriber (steps 506-520). Otherwise, the subscriber transmits in a forward channel (step 522). As mentioned above, the transmission may be voice, data, or control.

If, however, the channel is busy (step 504), then the subscriber determines if a remote control request message was previously sent (step 506). If a remote control request message was sent, then the subscriber being controlled is transmitting to the subscriber and the subscriber initiating an interrupt sends an interrupt message on the reverse channel to the subscriber being controlled (step 508). In one embodiment, the interrupt message is a specific remote of control message interrupt message.

If, however, a remote control request message was not previously sent (step 506), then the subscriber determines whether it is in an emergency mode (step 510). If the subscriber is in an emergency mode (step 510), then the subscriber transmits an emergency preemption on the reverse channel (step 512).

If, however, the subscriber is not in an emergency mode (step 510), then the subscriber determines whether there is a call on the forward channel (step 514). If there is not a call on the forward channel, then the subscriber can not interrupt the busy channel. If there is a call on the forward channel, the subscriber determines whether the subscriber is provisioned for polite channel access (step 516). If the subscriber is not provisioned for polite channel access (step 516), then the subscriber sends an interrupt message on the reverse channel (step 520).

As used herein, polite channel access means that the subscriber considers what type of communications are currently on the forward channel before accessing the forward channel for its own communication. A subscriber provisioned for polite channel access may be defined with rules governing access to the channel. For example, the subscriber may be polite to all voice communications on the channel, may be polite to only specific voice communications satisfying a criteria (e.g. color code), etc.

If, however, the subscriber is provisioned for polite channel access (step 516), then the subscriber determines whether it is a party to the voice, e.g. a call (step 518)? As used herein, being a party to the voice means that the subscriber is participating in the call. If the subscriber is not a party to the voice and the subscriber is provisioned for police channel access (step 518), then the subscriber can not interrupt the busy channel. Otherwise, the subscriber sends an interrupt message on the reverse channel (step 520).

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. A method for interrupting a transmitting subscriber, comprising:
at a first subscriber:
transmitting a communication on a forward channel of a wireless communications system while listening to a reverse channel for reverse channel signaling;
receiving reverse channel signaling on the reverse channel from a second subscriber, wherein the reverse channel signaling is received either directly from the second subscriber or through at least one base radio; and
terminating the communication on the forward channel in response to the received reverse channel signaling.

2. The method of claim 1 further comprising determining that the received reverse channel signaling indicates an interrupt message prior to terminating the communication on the forward channel.

3. The method of claim 2, wherein if the interrupt message is a transmitter interrupt, then the first subscriber determines whether the communication on the forward channel is voice before terminating the communication on the forward channel.

4. The method of claim 2 wherein a type of interrupt message is at least one of transmitter interrupt, emergency preemption, and control of remote monitor.

5. The method of claim 1 further comprising the second subscriber transmitting a second communication on the forward channel.

6. The method of claim 1 further comprising determining that the first subscriber is provisioned for reverse channel signaling before terminating the communication on the forward channel.

7. The method of claim 6 further comprising determining the first subscriber is provisioned for transmitter interrupt before terminating the communication.

8. The method of claim 1 wherein the second subscriber sends the reverse channel signaling if the second subscriber is a party to the communication and is provisioned for polite channel access.

9. The method of claim 1 wherein the second subscriber sends the reverse channel signaling if the second subscriber is not provisioned for polite channel access.

10. The method of claim 1, wherein the communication is a voice call.

11. The method of claim 1 further comprising:
transmitting non-voice on a forward channel of a TDMA wireless communications system while listening to a reverse channel for reverse channel signaling;
receiving reverse channel signaling on the reverse channel from a second subscriber, wherein the reverse channel signaling is received either directly from the second subscriber or through at least one base radio; and
not terminating the non-voice on the forward channel in response to the received reverse channel signaling.

12. A method for interrupting a transmitting subscriber, comprising:
at a first subscriber:
transmitting voice on a forward channel of a TDMA wireless communications system while listening to a reverse channel for reverse channel signaling;
receiving an outbound channel burst on the reverse channel from a second subscriber via at least one base radio, wherein the outbound channel burst comprises reverse channel signaling; and
terminating the voice on the forward channel in response to the received outbound channel burst.

13. The method of claim 12 further comprising:
at a second subscriber:
transmitting a communication on the forward channel while listening to the reverse channel for reverse channel signaling;
receiving a reverse channel burst from a third subscriber on an inbound channel, wherein the reverse channel burst comprises the reverse channel signaling;
determining the received reverse channel burst indicates an interrupt message; and
terminating the communication on the forward channel in response to the interrupt message.

14. The method of claim 13 wherein the reverse channel burst is carried only on a center of a time slot of the reverse channel.

15. The method of claim 13 wherein the interrupt message indicates an emergency preemption.

16. The method of claim 12 further comprising determining the communication is non-voice before terminating the communication on the forward channel.

17. The method of claim 12 wherein the first subscriber is provisioned for reverse channel signaling.

18. The method of claim 12 further comprising receiving a remote control request message prior to terminating the communication on the forward channel in response to a interrupt message.

19. The method of claim 12 further comprising determining that the first subscriber is provisioned for reverse channel signaling before terminating the communication on the forward channel.

20. The method of claim 12 wherein the reverse channel signaling is carried in between payload of the outbound channel burst.
